(19) United States
(12) Patent Application Publication
(10) Pub. No.: US 2013/0115715 A1
(43) Pub. Date: May 9, 2013

(54) METHOD OF SENSOR MEASUREMENT

(71) Applicant: Anders Hanning, Sollentuna (SE)

(72) Inventor: Anders Hanning, Sollentuna (SE)

(73) Assignee: Episentec AB, Sollentuna (SE)

(21) Appl. No.: 13/699,243

(22) PCT Filed: May 25, 2011
(86) PCT No.: PCT/EP2011/058574

§ 371 Date: Dec. 20, 2012

(30) Foreign Application Priority Data
May 27, 2010 (SE) 1000567-6
Oct. 11, 2010 (SE) 1001001-5
Oct. 29, 2010 (SE) 1001109-6
Apr. 28, 2011 (SE) 1100325-8

(51) Int. Cl. G06F 19/00

(52) U.S. Cl. CPC G06F 19/70
USPC 436/501; 702/22

(57) ABSTRACT

The present invention provides a method of determining the amount of an optical probe species binding to or releasing from an optical sensor surface characterized in that the determination comprises the steps of determining at least one physical measurand (x₁ᵢ) that is related to the refractive index of said probe at one single wavelength or at more than one wavelength, and further comprises determining at least one physical measurand (x₂ⱼ) that is related to the absorptivity of said probe at one single wavelength or at more than one wavelength, and further correlating the values of said measurands to the amount of said optical probe species binding to or releasing from said surface, respectively. There is also provided methods for calibration of an optical sensor as well as reagent kits and a computer program product.

### TECHNICAL FIELD OF THE INVENTION

The present invention relates to the field of optical sensor measurements, and in particular to methods determining the amount of an optical probe species binding to or releasing from an optical sensor surface as well as calibration methods for optical sensors.

### BACKGROUND ART

The use of chemical sensors and biosensors is well established. Such sensors usually consist of two distinguishable elements. One element provides the chemical or biochemical selectivity of the sensor; this element usually consists of a selective layer attached to a solid surface. The selectivity may be provided by e.g. a selectively absorbing matrix, a chelating agent, an antibody, a selectively binding protein, a nucleic acid strand, or a receptor. The determination of an analyte of interest in a sample usually involves the binding or release of the analyte, or the analyte influencing the binding or release of some other species, to or from the selective layer, respectively. The second element provides the monitoring of the binding or release of species to and from the sensor surface, respectively.

One important class of sensors is based on optical monitoring of the binding event; such sensors are called optical sensors. The optical readout mechanism may be based on changes in e.g. absorbance, fluorescence, or refractive index. Many such sensors are based on the phenomenon of internal reflection; for example, such sensors may be based on surface plasmon resonance (SPR), frustrated total internal reflection, optical waveguiding, critical angle refractometry, interference refractometry, dual polarization interferometry, and other methods. The following discussion is mainly focused on SPR sensors, but, as is obvious to the skilled person, many aspects of the discussion are also applicable to other kinds of optical sensors in general and internal reflection based sensors in particular.

Further, there are two main classes of SPR sensors. One is based on readout of the specific angle corresponding to the resonance at a defined wavelength; the other is based on readout of the specific wavelength corresponding to the resonance at a defined angle. There also exist hybrid variants where both the angle and the wavelength are varied. The following discussion is focused on SPR sensors with angular readout. Moreover, for simplicity, the discussion is focused on the so called Kretschmann SPR configuration, but the discussion may be applicable also to other configurations, like e.g. the Otto configuration and different configurations involving gratings and waveguides.

The use of SPR sensors is well-established (see e.g. L. M Lechuga, “Optical Biosensors”, Chap. 5 in “Biosensors and Modern Biospecific Analytical Techniques”, L. Gorton (ed.) Elsevier, Amsterdam, 2005; J. Homola, Chem. Rev. 2008, 108, 462). In general, different species can be analyzed in real time and without the use of any labels attached to the analytes. The sensitivity is adequate for many purposes, and so is the robustness. However, it is also well known that the use of SPR sensors in certain applications is problematic and that the performance of SPR sensors may be inadequate for some purposes. The sensitivity of SPR sensors, for example, is limited, and may be inadequate for the analysis of small molecules. Another problem may be the universal nature of the readout when labelling is not used; SPR has no inherent mechanism for distinguishing between the binding of the analyte and the binding of any other species. Especially problematic is the so called “non-specific binding” of proteins and other more or less well-defined species in connection with samples of biochemical origin. A third problem is the influence of a number of noise sources like e.g. temperature variations, mechanical vibrations, and spurious variations of the composition of the medium in contact with the sensor surface. As a consequence of these problems, quantitative analysis and sensor calibration may show insufficient accuracy and precision for SPR sensors.

SPR sensors are commonly used to measure the refractive index, i.e. the real part of the complex refractive index, of sample media. However, it is well-known that SPR sensors may also be used to indirectly measure the absorbance (a more correct term is extinction coefficient, but the term absorbance is used here since it is more easily understood), i.e. the imaginary part of the complex refractive index, since light absorption influences the shape of the SPR curve. Also the thickness of adsorbates on the sensor surface can be deducted from SPR measurements. The measurement of these three parameters is discussed by e.g. H. Kano and S. Kawata, Appl. Opt. 1994, 33, 5166; S. R. Karlsen et al., Sens. Actuators B 1995, 24-25, 747; Z. Salamon et al., Biochim. Biophys. Acta 1997, 1331, 117; A. A. Kolomenskii et al., Appl. Opt. 2000, 39, 3314; S. Wang et al., Rev. Sci. Instr. 2001, 72, 3055; and S. Ekgasit et al., Sens. Actuators B 2005, 105, 532.

SPR sensors have also been applied to monitor chromogenic reactions, i.e. chemical reactions accompanied by a colour change. Some examples are silver ion detection reported by Y. Hur et al., Anal. Chim. Acta 2002, 460, 133, and hydrogen ion detection reported by P. Uznanski and J. Pecherz, J. Appl. Pol. Sci. 2002, 86, 1459. However, chromogenic reactions represent a special case, since simple binding of chemical species to a solid surface is generally not accompanied per se by a colour change.

A number of attempts have been made to improve the performance of SPR sensors. In U.S. Pat. No. 5,573,956 is described how the use of refractive index-enhancing species may improve the sensitivity of SPR assays. Similar approaches have later been proposed by H. Komatsu et al., Sci. Tech. Adv. Mater. 2006, 7, 150, and by M. Nakkach et al., Appl. Opt. 2008, 47, 6177. In U.S. Pat. No. 5,641,640 is described how the measurement of the refractive index at more than one wavelength may increase the sensitivity and reduce some sources of noise. A similar approach was later discussed by O. Esteban et al., Opt. Lett. 2006, 31, 3089. In JP11118802 is discussed how a specimen of low concentration and low molecular weight may be determined by using light of a wavelength equal to the absorption wavelength of the specimen or a pigment bound thereto. In WO02073171 is briefly noted that the absorbance of a sample may be measured via changes in the shape (reflectance minimum and dip width) of the SPR curve. In JP2002090291 is discussed how an SPR sensor may detect low-molecular matter such as ions by utilizing a sensing layer containing matter which changes its optical absorption characteristics by capturing low molecular matter; i.e. by utilizing a chromogenic indicator. In JP2002357536 is noted that a light absorbing substance may be used to increase the sensitivity of SPR assays in a manner similar to the above mentioned U.S. Pat. No. 5,573,956 and U.S. Pat. No. 5,641,640. It is also, in a manner similar to the above mentioned WO02073171, noted that an absorbing substance may change the shape of the SPR curve. In JP2003215029 is discussed an apparatus for the measurement of both surface plasmon resonance and optical absorption spectra; it is to be noted that the apparatus utilizes wavelength readout, not angular readout, so discussing the shape of the angular readout SPR curve is not relevant in this case.

However, in spite of these attempts, there still exist problems related to the signal-to-noise ratio, the noise level, and the calibration of SPR sensors. In theory, the ultimate noise level of SPR sensors may depend on the performance of the optical and electronic components of the sensor system (see e.g. G. G. Nenninger et al., Meas. Sci. Technol. 2002, 13, 2038; M. Piliarik and J. Homola, Opt. Express 2009, 17, 16505). However, in most practical, experimental situations the noise is determined by such aforementioned factors as temperature fluctuations, non-specific binding, and spurious concentration variations. It has not previously been realized, that by evaluating more than one parameter of the SPR curve, such practical noise factors may largely be cancelled. Neither has it previously been realized, that by evaluating more than one parameter of the SPR curve, new and improved calibration procedures for optical sensors may be developed. The present invention provides such improved methods and procedures.

### SUMMARY OF THE INVENTION

As a first aspect of the invention, there is provided method of determining the amount of an optical probe species binding to or releasing from an optical sensor surface characterized in that the determination comprises the steps of:

a) determining at least one physical measurand (x₁ᵢ) that is related to the refractive index of said probe at one single wavelength or at more than one wavelength, and further comprises

b) determining at least one physical measurand (x₂ⱼ) that is related to the absorptivity of said probe at one single wavelength or at more than one wavelength, and further

c) correlating the values of said measurands to the amount of said optical probe species binding to or releasing from said surface, respectively.

Thus, in a wide sense, the present invention is based on the idea that a method of determining the amount of an optical probe species binding to or releasing from an optical sensor surface may be improved if the determination comprises determining at least one physical measurand that is related to the refractive index of said probe at one single wavelength or at more than one wavelength, and further comprises determining at least one physical measurand that is related to the absorptivity of said probe at one single wavelength or at more than one wavelength, and further comprises correlating the values of said measurands to the amount of said optical probe species binding to or releasing from said surface, respectively. The present invention is also based on the insight in how to use information from measurands that relates to the refractive index and the absorptivity, or one such measurand when measured at different wavelengths (or defined angles), for calibration and reducing noise in an optical sensor and for quantifying the amount of an optical probe that binds to the sensor. Several aspects and configurations of the general inventive concept is disclosed herein.

In embodiments of the invention, the determination is influenced by measurement noise, and step c) of the method comprises using the values of said measurands to discriminate between measurement noise and the binding or release of said optical probe species. Measurement noise, emanating from different sources, and binding or release of the optical probe per se, respectively, will contribute in different ways to the set of measurands, and by analyzing the pattern of variation of the set of measurands, it is possible to discriminate between the contributions from the noise and from the optical probe, respectively.

Therefore, as an alternative or configuration of the first aspect, there is provided a method of reducing noise in an optical sensor, comprising the steps of:

a) determining at least one physical measurand (x₁ᵢ) that is related to the refractive index of an optical probe at one single wavelength or at more than one wavelength, and further comprises

b) determining at least one physical measurand (x₂ⱼ) that is related to the absorptivity of said probe at one single wavelength or at more than one wavelength, and further

c) using the physical measurands x₁ᵢ and x₂ⱼ from steps a) and b) for reducing noise when determining the amount of said optical probe species binding to or releasing from the optical sensor surface.

In other words, or a further alternative or configuration of the first aspect, there is provided a method for determining the amount of an optical probe species binding to or releasing from an optical sensor surface comprising utilizing information obtained from at least one physical measurand (x₁ᵢ) that is related to the refractive index of said probe and at least one physical measurand (x₂ⱼ) that is related to the absorptivity of said probe. In the present context, the expression “optical probe” is used to denote a species that is binding to or releasing from an optical sensor surface, and which may be detected by the sensor, and which has a detectable absorbance at least one measurement wavelength. In case the analyte itself fulfils these conditions, it may be used as an optical probe per se. The optical probe may also have fluorescent properties. However, in most cases the optical probe is used to determine the amount or concentration of analyte in a more indirect way; the analyte may e.g. affect the binding or release of the optical probe to or from, respectively, the optical surface. Conceivable ways to achieve this include, but are not limited to, a sandwich assay, a competition assay, an inhibition assay, or a displacement assay. In some conceivable embodiments, the optical probe may be used to chemically label some other species; e.g. the analyte itself may be labelled, a competing or analogous species to the analyte may be labelled, or some secondary or tertiary reagent, e.g. a secondary antibody, may be labelled.

The expression “noise” or “measurement noise” is to be interpreted in a wide sense. It is used to denote any contribution to any measurand that obscures, disturbs, or interferes with the determination of the optical probe species, i.e. not only short-term random variations of the measurands. In particular, the term is used to denote unwanted or uncontrolled temperature variations, spurious variations of the composition of the medium in contact with the sensor surface, and unwanted or uncontrolled binding or release of any other chemical species to or from, respectively, the sensor surface. So called “non-specific binding” is included in the definition of “noise”. It is to be understood that several, defined or undefined, sources of noise may contribute simultaneously. The different sources of noise may contribute in a similar or dissimilar way to the set of measurands. In most cases, the contribution from different sources of noise can be summed up in an additive way.

The optical properties of the optical probe are described by its complex refractive index. The shorter term “refractive index” is used to denote the stricter term “real part of the complex refractive index”. The terms “extinction coefficient” and “absorbance” are used to denote “imaginary part of the complex refractive index”. The complex refractive index is strictly a property of an optical continuum; when discussing properties of discrete chemical species, like e.g. molecules, terms like “molar refractive index increment” and “absorptivity” may be used since they may be more easily understood. The distinction and relationship between optical continuum properties and the optical properties of discrete species are well known to the skilled person.

The term “one wavelength” is used to denote a sharp wavelength peak or a narrow wavelength interval, such as that that may be obtained from a light emitting diode or a laser, or a broadband light source or a light source emitting several wavelengths together with a bandpass filter or a monochromator.

A “physical measurand” relates to a physical property, e.g. a property of the studied system, that is influenced by the binding or releasing of an optical probe at a sensor surface, which also can be measured or estimated with the optical sensor. The invention includes the embodiments in which more than one measurand is determined in step a) and b), i.e. step a) may include determining more than one physical measurand that is related to the refractive index (x₁₁-x₁ₘ) and step b) may include determining more than one measurand that is related to the absorptivity (x₂₁-x₂ₙ). Step c) may then include correlating all of x₁₁-x₁ₘ and x₂₁-x₂ₙ to the amount of said optical probe species binding to or releasing from the surface.

It is to be understood that in the present disclosure, “m” refers to the number of the first physical measurands (x₁ᵢ) that are determined and that “n” refers to the number of the second physical measurands (x₂ⱼ) that are determined.

The at least one physical measurand (x₁ᵢ) and the least one physical measurand (x₂ⱼ) that are determined according to any aspect of the invention may thus form a set of measurands: {x₁₁, . . . , x₁ₘ; x₂₁, . . . , x₂ₙ} where m≧1, n≧1.

Further, the measurands of step a) and b) may be the same measurand if determined at different wavelengths in steps a) and b) and/or if the measurand is related to both the refractive index and the absorptivity of the optical probe.

The term “measurand that is related to the refractive index” (and similar terms) should not be interpreted too strictly: most measurands are influenced, to a smaller or larger extent, both by refractive index and by absorbance. The term is used to denote measurands that are primarily influenced by refractive index changes and less by absorbance changes. The term “measurand that is related to the absorptivity” (and similar terms) is to be interpreted in an analogous way. The full quantitative relationship between the measurands and the complex refractive index is described by the fundamental laws of optics.

The advantages of the invention will be better understood from the following discussion of the beneficial influence of different aspects and embodiments of the invention. Clarifying examples will mainly refer to the use of SPR sensors with angular readout, but, as will be apparent to the skilled person, the invention is not limited to such sensors.

Consequently, the first aspect of the invention is based on the insight that measuring at least one measurand that is related to the refractive index and at least one measurand that is related to the absorptivity and using these (or the information obtained from the measurands) when determining the amount of an optical probe species binding to or releasing from an optical sensor surface leads to results that are less influenced by noise.

In an embodiment of the first aspect, the correlation of step c) involves multiple linear regression, principal component analysis, factor analysis, principal component regression, partial least squares or any method of linear algebra or multivariate data analysis.

Such calculation methods are very useful for purposes of determining the amount of the optical probe binding to or releasing from the sensor surface, using the physical measurands x₁ᵢ and x₂ⱼ. As examples, in step c), calibration data may e.g. be evaluated by means of multiple linear regression, or, in the case of over-determined data sets, by principal component analysis or partial least squares. Quantification of e.g. the optical probe binding to or releasing from the surface may be performed by e.g. solving a linear equation system. Unknown factors may be extracted from a data set by means of factor analysis. There are also other methods, known to the skilled person, of linear algebra and multivariate data analysis that may be used for data evaluation according to the methods of the present invention.

Further, in embodiments of the first aspect, step c) comprises using the values of said measurands to discriminate between measurement noise (N) and the binding or release of said optical probe species.

Consequently, the method of the first aspect provides for more accurate results when determining interactions between the optical probe and the sensor surface.

As a compliment or as an alternative, step c) may comprise the steps:

c1) using the physical measurands x₁ᵢ and x₂ⱼ for reducing noise in the optical sensor, and

c2) determining the amount of said optical probe species binding to or releasing from said surface.

Consequently, the determination of step c2) is less influenced by noise compared to if steps a) and b) were not carried out. Further, when discussing step c) in the present disclosure, the embodiments may refer to step c1) above.

As an example, step c) (or step c1)) may comprise determining at least one function f of the set of measurands: f({x₁₁, . . . , x₁ₘ; x₂₁, . . . , x₂ₙ}) such that the signal-to-noise ratio (S/N) of the optical probe binding to or releasing from said optical sensor surface increases, wherein m≧1, n≧1.

The skilled person understands how to determine a function such that the signal-to-noise ratio increases. This may be performed e.g. by iterative processes.

Further, this means that f({x₁₁, . . . , x₁ₘ; x₂₁, . . . , x₂ₙ}) may be determined such that S/N of f({x₁₁, . . . , x₁ₘ; x₂₁, . . . , x₂ₙ}) is increased compared to S/N of any x₁ᵢ or x₂ⱼ.

The function f({x₁₁, . . . , x₁ₘ; x₂₁, . . . , x₂ₙ}) may then further be evaluated and analysed, e.g. by plotting f({x₁₁, . . . , x₁ₘ; x₂₁, . . . , x₂ₙ}) versus time, for determining interactions between the optical probe and the sensor surface. The plot of f({x₁₁, . . . , x₁ₘ; x₂₁, . . . , x₂ₙ}) versus time is thus less influenced by noise compared to a plot of any x₁ᵢ or x₂ⱼ versus time. This is further demonstrated in the Examples of the present disclosure.

As an example, f may be a linear combination: f=Σᵢ₌₁^{m} (k₁ᵢ x₁ᵢ)+Σⱼ₌₁ⁿ (k₂ⱼ x₂ⱼ).

Further, the determination may involve estimating at least one constant k₁ᵢ or k₂ⱼ in f=Σᵢ₌₁^{m} (k₁ᵢ x₁ᵢ)+Σⱼ₌₁ⁿ (k₂ⱼ x₂ⱼ) such that the signal-to-noise ratio (S/N) of the optical probe binding to or releasing from said optical sensor surface increases.

As an example, a single measurand x₁₁ is determined in step a) and a single measurand x₂₁ is determined in step b) and the determination of step c) involves estimating a constant k in f(x₁₁,x₂₁)=x₁₁+k*x₂₁ such that the signal-to-noise ratio (S/N) of the optical probe binding to or releasing from said optical sensor surface increases.

In embodiments of the first aspect, the measurement noise (N) is due to at least one additional chemical species binding to or releasing from said surface, and that step c) comprises using the values of said measurands to discriminate between binding or releasing of said optical probe species and said at least one additional chemical species.

This embodiment includes the case of “non-specific binding”. In this aspect, as in other aspects, it is not excluded that several sources of noise may contribute simultaneously in a similar or dissimilar way. As an example, non-specific binding of uncoloured proteins (like e.g. albumin) to the surface contributes primarily to refractive index-related measurands and less to absorbance-related measurands, while optical probe binding will contribute heavily to absorbance-related measurands. Still, the cross terms (contribution of proteins to absorbance-related measurands and contribution of optical probe to refractive index-related measurands) may not be totally neglected, and, in order to obtain the highest signal-to-noise ratio, the cross terms should also be considered. Unwanted binding of absorbing chemical species will, of course, also contribute heavily to absorbance-related measurands, but as long as the contribution to the different measurands shows a different pattern than that of the optical probe, the different contributions may be resolved by mathematical techniques.

As an example, the measurement noise (N) may have been determined by means of varying the binding or release of an additional chemical species to or from, respectively, said optical sensor surface.

The binding or release may have been varied in a controlled way.

In embodiments of the first aspect, the measurement noise (N) is due to temperature variations, and that step c) comprises using the values of said measurands to discriminate between binding or releasing of said optical probe species and temperature variation noise.

Temperature variations mainly contribute to refractive index-related measurands. The refractive index of water, e.g., decreases with 0.0001 refractive index units for each 1° C. temperature increase. The contribution of temperature variations to absorbance related-measurands, on the other hand, is significantly smaller, unless the medium in contact with the optical probe surface is strongly absorbing. Again, for the highest signal-to-noise ratio, also the cross-terms (contribution of temperature variations to absorbance-related measurands and contribution of optical probe to refractive index-related measurands) should in any case be considered.

As an example, the measurement noise (N) may have been determined by means of varying the temperature of the medium in contact with said optical sensor surface.

The temperature may have been varied in a controlled way.

In embodiments of the first aspect, the measurement noise is due to variations of the composition of the medium in contact with the sensor surface, and that step c) comprises using the values of said measurands to discriminate between binding or releasing of said optical probe species and said variations of the composition.

Again, as long as the composition variations are due to uncoloured species, the influence will be mainly on refractive index-related measurands, while coloured species will influence also absorbance-related measurands heavily. For the highest signal-to-noise ratio, also the cross-terms (contribution of composition variations to absorbance-related measurands and contribution of optical probe to refractive index-related measurands) should in any case be considered.

As an example, the measurement noise (N) may have been determined by means of varying the composition of the medium in contact with said optical sensor surface.

The composition may have been varied in a controlled way and the medium may for example be a buffer.

As a second aspect of the invention, there is provided a method for calibration of an optical sensor for the determination of the amount of an optical probe species binding to or releasing from an optical sensor surface, said determination being influenced by measurement noise, wherein the calibration method comprises

a) determining at least one physical measurand (x₁ᵢ) that is related to the refractive index of said probe at one single wavelength or at more than one wavelength, and

b) determining at least one physical measurand (x₂ⱼ) that is related to the absorptivity of said probe at one single wavelength or at more than one wavelength, and further

c) quantifying the specific contribution from the binding or releasing of said optical probe species to at least one of the measurands (x₁ᵢ) or (x₂ⱼ).

The terms and definitions used in the second aspect of the invention are as defined in connection with the first aspect of the invention hereinabove.

The second aspect of the invention are based on the insight that a method for calibration of an optical sensor for the determination of the amount of an optical probe species binding to or releasing from an optical sensor surface, said determination being influenced by measurement noise, may be improved if the calibration method comprises determining at least one physical measurand (x₁ᵢ) that is related to the refractive index of said probe at one single wavelength or at more than one wavelength, and determining at least one physical measurand (x₂ⱼ) that is related to the absorptivity of said probe at one single wavelength or at more than one wavelength.

The term “calibration” is used here to denote any procedure for improving the quantitative accuracy or precision of an analytical method. Calibration is usually performed as a separate experimental step before (or after) the analytical step per se. During the calibration step, the specific contribution of the binding or release of the optical probe and/or the contribution of at least one source of noise to the set of measurands is determined in a quantitative or semi-quantitative way. During the analytical step, the so determined specific contributions are utilized to improve the accuracy or the precision through a mathematical procedure.

In a simple case, one and the same measurand, e.g. the angular position of the SPR curve minimum reflectance, may be determined at two different wavelengths. In this example, the total number of measurands is two, while the number of different kinds on measurands is one.

The “quantification” of step c) may be performed in analogy with the step of “correlating” in relation to the first aspect above. This further illustrated in the Examples of the present disclosure, for example in Examples 1a-1b, 2, 8 and 10.

In embodiments of the second aspect, the quantification of step c) involves multiple linear regression, principal component analysis, factor analysis, principal component regression, partial least squares or any method of linear algebra or multivariate data analysis.

In embodiments of the second aspect, step c) comprises varying the binding or release of an additional chemical species to or from, respectively, said optical sensor surface, and further comprises quantifying the specific contribution from the binding or releasing of said additional chemical species to at least one of the measurands.

The binding or release may be varied in a controlled way.

By quantitatively determining the specific contribution of e.g. “non-specific binding” in this way, the influence of non-specific binding may be quantitatively compensated for in the subsequent analysis step through mathematical back-calculation. Non-specific binding from the sample may e.g. be studied in a separate experiment run under conditions where no binding of the analyte or the optical probe to the surface occurs. It may not be necessary to determine the contribution from the additional chemical species in absolute terms (for example in refractive index units per surface concentration in pg/mm²), but only to determine the pattern of the contribution to the set of measurands. As above, in order to obtain the highest possible accuracy and precision, it may be necessary to carefully quantify the contribution of the optical probe and that of the additional species, respectively, to all the measurands; i.e. to consider also the cross terms.

In embodiments of the second aspect, step c) comprises varying the temperature of the medium in contact with said optical sensor surface, and further comprises quantifying the specific contribution from said temperature variations to at least one of the measurands.

The temperature may be varied in a controlled way.

Varying the temperature may involve applying a more or less exactly known temperature increase (or decrease) to the medium in contact with the sensor surface by some means, and determining the pattern of variation of the set of measurands. This information may then be used to compensate for temperature noise in the analytical step. As above, it may be necessary to include also the cross terms.

In embodiments of the second aspect, step c) comprises varying the composition of the medium in contact with said optical sensor surface, and further comprises quantifying the specific contribution from said composition variations to at least one of the measurands.

The composition may be varied in a controlled way.

In a simple experiment, the salt or sugar concentration of the medium in contact with the sensor surface may be varied, and the pattern of influence on the set of measurands may be determined. This information may then be used to compensate for composition variation noise in the subsequent analytical step. Again, it may be necessary to include also the cross terms

In embodiments of the second aspect, the method does not involve binding to or release from, respectively, of said optical probe species to said optical sensor surface.

This is advantageous in that it does not require information from experiments where the optical probe binds to the sensor surface, i.e. it provides a simpler and less complicated way of calibration.

In these embodiments, the optical probe species may simply be dissolved in the medium in contact with the sensor surface, and an experiment may be performed under conditions of no binding to the surface. In this way, the pattern of the variation of the measurands may be determined, and may be used for purposes of calibration. In most cases, it is a good approximation to assume that the pattern of variation of the measurands will be the same for dissolved optical probe as for surface-bound optical probe. Actually, some uncontrolled amount of binding may take place, and the contribution from dissolved probe and bound probe may be assumed to sum up in a simple additive way. Again, it may be sufficient to determine the pattern of variation of measurands rather than the absolute value of the variation of individual measurands.

In embodiments of the second aspect, the method does not involve varying the measurement noise.

As an example, the method does not involve varying the measurement noise in a controlled way.

This is advantageous in that it only requires noise from the baseline of the sensing signal in order to calibrate the sensor, i.e. it provides a simpler and less complicated way of calibration.

A calibration experiment may be performed, in which the noise is allowed to contribute in an uncontrolled way. The pattern of influence on the set of measurands from this uncontrolled noise may be determined and used for purposes of calibration. The calibration experiment may or may not involve the simultaneous determination of the contribution from the optical probe on the set of measurands. The different contributions (from the optical probe and from the different sources of noise, respectively) may e.g. be separated from each other through the method of multivariate factor analysis.

In embodiments of the first and second aspects of the invention, the sensing principle of the optical sensor is based on internal reflection.

Internal reflection is often used in connection with chemical sensors and biosensors. The internally reflected light creates an evanescent wave that is used for probing the sensor surface and its immediate environment. One advantage of internal reflection methods is that the probing light beams need not pass through the sample solution, which could otherwise cause problems related to the absorption and scattering of light.

In embodiments of the first aspect, the sensing principle of the optical sensor is based on optical waveguiding refractometry, including but not limited to frustrated total internal reflection (resonant mirror technique), waveguide-based surface plasmon resonance, and grating coupler refractometry, or interference refractometry, including but not limited to dual polarization.

As a consequence, the sensing principle of the optical sensor may be based on optical waveguiding refractometry, frustrated total internal reflection, waveguide-based surface plasmon resonance, grating coupler refractometry, interference refractometry, or dual polarization interferometry.

Common to these methods are that they are used to probe the refractive index close to the sensor surface, but that also absorbance of light on or in the immediate vicinity of the surface will influence the measurement.

As an further example, the sensing principle of the optical sensor may be based on surface plasmon resonance (SPR) with angular readout. This is probably the most used method for biosensing. Also this method is primarily intended for refractometry, but the measurement is also influenced by absorbance of light on or in the immediate vicinity of the surface. This influence is usually considered to be a disadvantage of the method, but, as is detailed in the description of the present invention, it can also be turned into a distinct advantage.

As an example, the at least one measurand (x₁ᵢ) that is related to the refractive index of said probe may be selected among the angle of minimum reflectivity and the centre of gravity of the SPR curve.

These measurands are the ones most often used to monitor refractive index changes in SPR sensors. There are also other conceivable measurands that describe the movement of the SPR curve in the angular domain.

Further, the at least one measurand (x₂ⱼ) that is related to the absorptivity of said probe may be selected among the minimum reflectance value, the width, the standard deviation, the skewness, and the kurtosis of the SPR curve.

It is well known that the minimum reflectance and the shape of the SPR curve are related to the absorbance of the sample. Apart from the measurands explicitly mentioned here, there are also other conceivable measurands that may be related to the shape of the SPR curve.

In embodiments of any aspect of the invention, the measurands (x₁ᵢ and x₂ⱼ) are selected among reflectivity values at defined angles in the SPR curve

In this embodiment, “raw” reflectance or light intensity values are being used and no recalculation in terms of curve position or shape is made. One advantage is that no assumptions have to be made as to which measurands are coupled to the refractive index and which are coupled to the absorptivity. The data may be evaluated by means of a variety of multivariate pattern recognition techniques or soft modelling techniques.

Thus, it follows from this embodiment that the measurands of step a) and b) in the first and second aspects may be the same measurand, e.g. the reflectivity value, when using different defined angles or different defined wavelengths for determining the measurands in steps a) and b), if this measurand is related to both the refractive index and the absorptivity. As an example, the raw reflectance values is a measurand that is related to both the refractive index and the absorptivity when using an SPR sensor with angular readout. Consequently, determining a physical measurand at one defined angle may give an x₁ᵢ in step a) and determining the same measurand at another defined angle may give an x₂ⱼ in step b). Further, the same measurand may be determined at more than two defined angles and multivariate data analysis may be used in step c) for e.g. determining the amount of optical probe binding to or releasing from the sensor surface.

In embodiments of the first and second aspect of the invention, the determination of said at least one physical measurand (x₁ᵢ) that is related to the refractive index of said probe is made at one single wavelength, and further that the determination of said at least one physical measurand (x₂ⱼ) that is related to the absorptivity of said probe is made at one single wavelength.

This represents a simple case where the number of measurement wavelengths is limited; it may still be sufficient to improve the performance of the method

In embodiments of the first and second aspect, the determination of said at least one physical measurand (x₁ᵢ) that is related to the refractive index of said probe and the determination of said at least one physical measurand (x₂ⱼ) that is related to the absorptivity of said probe is made at one and the same single wavelength. This represents the simplest case in terms of number of wavelengths. An obvious advantage of this variant is the experimental simplicity; a single wavelength LED or laser may be used as the light source, or a broadband light source may be used together with a bandpass filter or a fixed monochromator.

In embodiments of the first and second aspect of the invention, the number of said measurands (x₁ᵢ) that is related to the refractive index of said probe is one and that the number of said measurands (x₂ⱼ) that are related to the absorptivity of said probe is one.

Again, this represents a simple case where the number of measurands is limited to two. The two measurements may be performed at two different or at one single wavelength. In another aspect, the present invention provides a method characterized in that that the total number of the measurands is larger than two. This case may provide the advantage that the calibration method is based on an over-determined data set, in which case the noise level may be further reduced.

In embodiments of the first and second aspect of the invention, the total number of said measurands (x₁ᵢ, and x₂ⱼ) is larger than two.

Further, embodiments of the first and second aspect of the invention, at least one measurement wavelength is selected close to the wavelength of maximum absorptivity of said probe, preferably within 50 nm from the maximum, and more preferably within 20 nm from the maximum.

One advantage of this embodiment is that the influence on the refractive index is small close to the absorption maximum of absorbing substances. To a first simplified approximation, the contribution of the optical probe to the refractive index-related measurands may even be neglected, and the optical probe may be regarded as contributing only to the absorbance-related measurands.

As a third aspect of the invention, there is provided a method for calibration of an optical sensor for the determination of the amount of an optical probe species binding to or releasing from the optical sensor surface, said determination being influenced by measurement noise, comprising the steps

a) determining at least one physical measurand (x₁ᵢ) that is related to the refractive index of said probe at least two wavelengths, and

b) quantifying the specific contribution from the binding or releasing of said optical probe species to at least one of the measurands, wherein the method does not involve varying the binding or release of an additional chemical species to or from, respectively, said optical sensor surface.

The terms and definitions used in connection with the third aspect are as defined in relation to the first and second aspects above.

The third aspect of the invention is based on the insight that by determining at least one physical measurand that is related to the refractive index of a probe at least two wavelengths, a calibration may be performed without information from the binding of an additional chemical species to the sensor surface, as seen in the Examples of the present disclosure. Thus, this is advantageous in that it requires fewer steps for performing the calibration of the optical sensor Also, the risk that the additional chemical species will bind irreversibly to the surface and/or alter the chemical properties of the surface is omitted. Subsequent washing steps, that may also influence the chemical properties of the surface, can also be excluded.

As described in relation to the second aspect above, in embodiments of the third aspect of the invention, the quantification of step b) involves multiple linear regression, principal component analysis, factor analysis, principal component regression, partial least squares or any method of linear algebra or multivariate data analysis.

In embodiments of the third aspect of the invention, step b) comprises varying the temperature of the medium in contact with said optical sensor surface, and further comprises quantifying the specific contribution from said temperature variations to at least one of the measurands.

The temperature may be varied in a controlled way.

In embodiments of the third aspect, step b) comprises varying the composition of the medium in contact with said optical sensor surface, and further comprises quantifying the specific contribution from said composition variations to at least one of the measurands.

The composition may be varied in a controlled way.

In embodiments of the third aspect, the method does not involve binding to or release from, respectively, of said optical probe species to said optical sensor surface.

In embodiments of the third aspect the method does not further involve varying the measurement noise.

As an example, the method does not further involve varying the measurement noise in a controlled way.

In embodiments of the third aspect, the sensing principle of the optical sensor is based on internal reflection.

As an example, the sensing principle of the optical sensor is based on optical waveguiding refractometry, frustrated total internal reflection, waveguide-based surface plasmon resonance, grating coupler refractometry, interference refractometry, or dual polarization interferometry.

As a further example, the sensing principle of the optical sensor is based on surface plasmon resonance (SPR) with angular readout.

As a configuration of the third aspect of the invention, there is provided a method for calibration of a surface plasmon resonance (SPR) sensor with angular readout for the determination of the amount of an optical probe species binding to or releasing from said SPR sensor surface, said determination being influenced by measurement noise, comprising the steps

a) determining at least one reflectivity value at defined angles in the SPR curve at least two wavelengths, and

b) quantifying the specific contribution from the binding or releasing of said optical probe species to at least one of the reflectivity values.

This configuration of the calibration thus utilizes “raw” reflectance or light intensity values for calibrating an SPR sensor and no recalculation in terms of curve position or shape is required. One advantage is that no assumptions have to be made as to which measurands are coupled to the refractive index and which are coupled to the absorptivity. The data may be evaluated by means of a variety of multivariate pattern recognition techniques or soft modelling techniques.

Examples of this configuration are seen in Example 2 and 10.

As an example of this configuration of the third aspect, quantification of step b) involves multiple linear regression, principal component analysis, factor analysis, principal component regression, partial least squares or any method of linear algebra or multivariate data analysis.

As a further example of this configuration of the third aspect, step b) comprises varying the temperature of the medium in contact with said SPR sensor surface, and further comprises quantifying the specific contribution from said temperature variations to at least one of the reflectivity values.

The temperature may be varied in a controlled way.

As an example of this configuration of the third aspect, the method comprises varying the composition of the medium in contact with said SPR sensor surface, and further comprises quantifying the specific contribution from said composition variations to at least one of the reflectivity values.

The composition may be varied in a controlled way.

As an example of this configuration of the third aspect, the method does not involve binding to or release from, respectively, of said optical probe species to said optical sensor surface.

As a further example of this configuration of the third aspect, the method does not involve varying the measurement noise.

As an example, the method does not involve varying the measurement noise in a controlled way.

The advantages of the embodiments and examples of the configurations of the third aspect of the invention are as described in relation to the first and second aspect of the invention above.

In a further configuration of the third aspect of the invention, there is provided a method for calibration of an optical sensor for the determination of the amount of an optical probe species binding to or releasing from an optical sensor surface, said determination being influenced by measurement noise, comprising the steps

a) determining at least one physical measurand (x₁ᵢ) that is related to the refractive index of said probe at least two wavelengths, and

b) quantifying the specific contribution from the binding or releasing of said optical probe species to at least one of the measurands, wherein step b) comprises varying the temperature of the medium in contact with said optical sensor surface, and further comprises quantifying the specific contribution from said temperature variations to at least one of the measurands.

In a further configuration of the third aspect of the invention there is provided a method for calibration of an optical sensor for the determination of the amount of an optical probe species binding to or releasing from an optical sensor surface, said determination being influenced by measurement noise, comprising the steps

a) determining at least one physical measurand (x₁ᵢ) that is related to the refractive index of said probe at least two wavelengths, and

b) quantifying the specific contribution from the binding or releasing of said optical probe species to at least one of the measurands, wherein step b) comprises varying the composition of the medium in contact with said optical sensor surface, and further comprises quantifying the specific contribution from said composition variations to at least one of the measurands.

In a further configuration of the third aspect of the invention there is provided a method for calibration of an optical sensor for the determination of the amount of an optical probe species binding to or releasing from the optical sensor surface, said determination being influenced by measurement noise, comprising the steps

a) determining at least one physical measurand (x₁ᵢ) that is related to the refractive index of said probe at least two wavelengths, and

b) quantifying the specific contribution from the binding or releasing of said optical probe species to at least one of the measurands, wherein, the method does not involve binding to or release from, respectively, of said optical probe species to said optical sensor surface.

In a further configuration of the third aspect of the invention there is provided a method for calibration of an optical sensor for the determination of the amount of an optical probe species binding to or releasing from the optical sensor surface, said determination being influenced by measurement noise, comprising the steps

a) determining at least one physical measurand (x₁ᵢ) that is related to the refractive index of said probe at least two wavelengths, and

b) quantifying the specific contribution from the binding or releasing of said optical probe species to at least one of the measurands, wherein the method does not involve varying the measurement noise.

The sensing principle of the optical sensor in these configurations may be based on internal reflection.

As an example, the sensing principle of the optical sensor is based on optical waveguiding refractometry, frustrated total internal reflection, waveguide-based surface plasmon resonance, grating coupler refractometry, interference refractometry, or dual polarization interferometry.

As a further example, the sensing principle of the optical sensor is based on surface plasmon resonance (SPR) with angular readout.

It is further to be understood that in all calibration aspects of the present invention, the step of quantifying may comprise the same mathematical procedures as described in relation to the step of correlating according to the first aspect of the invention.

As an example, the step of quantifying may comprise determining at least one function f of the set of measurands: f({x₁₁, . . . , x₁ₘ; x₂₁, . . . , x₂ₙ}) such that the signal-to-noise ratio (S/N) of the optical probe binding to or releasing from said optical sensor surface increases, wherein m≧1, n≧1.

The skilled person understands how to determine a function such that the signal-to-noise ratio increases. This may be performed e.g. by iterative processes.

Further, this means that f({x₁₁, . . . , x₁ₘ; x₂₁, . . . , x₂ₙ}) may be determined such that S/N of f({x₁₁, . . . , x₁ₘ; x₂₁, . . . , x₂ₙ}) is increased compared to S/N of any x₁ᵢ or x₂ⱼ.

As an example, f may be a linear combination: f=Σᵢ₌₁^{m} (k₁ᵢ x₁ᵢ)+Σⱼ₌₁ⁿ (k₂ⱼ x₂ⱼ).

Further, the quantification may involve estimating at least one constant k₁ᵢ or k₂ⱼ in f=Σᵢ₌₁^{m} (k₁ᵢ x₁ᵢ)+Σⱼ₌₁ⁿ (k₂ⱼ x₂ⱼ) such that the signal-to-noise ratio (S/N) of the optical probe binding to or releasing from said optical sensor surface increases.

As an example, measurands x₁₁ and x₂₁ are determined the step of quantifying involves estimating a constant k in f(x₁₁,x₂₁)=x₁₁+k*x₂₁ such that the signal-to-noise ratio (S/N) of the optical probe binding to or releasing from said optical sensor surface increases.

This is further demonstrated in the Examples of the present disclosure.

As a fourth aspect of the invention, there is provided the use of at least one physical measurand (x₁ᵢ) that is related to the refractive index of an optical probe and at least one physical measurand (x₂ⱼ) that is related to the absorptivity of said probe in a method for determining the amount of said optical probe binding to or releasing from an optical sensor surface.

As a fifth aspect of the invention, there is provided the use of at least one physical measurand (x₁ᵢ) that is related to the refractive index of an optical probe and at least one physical measurand (x₂ⱼ) that is related to the absorptivity of said probe in a method for reducing noise in an optical sensor.

As a sixth aspect of the invention, there is provided the use of at least one physical measurand (x₁ᵢ) that is related to the refractive index of an optical probe and at least one physical measurand (x₂ⱼ) that is related to the absorptivity of said probe for calibrating an optical sensor.

The terms and definitions used in the fourth to sixth aspects of the invention are as defined in connection with the other aspects of the invention hereinabove. The fourth to sixth aspects of the invention are advantageous in that they provide for a determination of the amount of an optical probe species binding to or releasing from an optical sensor surface that is less influenced by noise.

As an seventh aspect of the invention, there is provided the use of an optical probe in any method according to the first to third aspects above.

Such use is thus advantageous in that it e.g. provides for performing the method according to the first, second and/or third aspect above.

As an eighth aspect of the invention, there is provided a computer program product comprising computer-executable components for causing a device to perform any one or all of the steps recited in any one of the aspects or embodiments of the present invention when the computer-executable components are run on a processing unit included in the device.

As an example, the computer program product may include a software for performing at least step c) in any method according to the aspects of the invention. Thus, the computer program product may comprise a software e.g. for determining or estimating a function f of the set of measurands: f({x₁₁, . . . , x₁ₘ; x₂₁, . . . , x₂ₙ}) such that the signal-to-noise ratio (S/N) of the optical probe binding to or releasing from said optical sensor surface increases, wherein m≧1, n≧1.

As an example, the software may be used for estimating at least one constant k₁ᵢ or k₂ⱼ in f=Σᵢ₌₁^{m} (k₁ᵢ x₁ᵢ)+Σⱼ₌₁ⁿ (k₂ⱼ x₂ⱼ) such that the signal-to-noise ratio (S/N) of the optical probe binding to or releasing from said optical sensor surface increases. Thus, the software could be used for estimating a constant k in f(x₁₁,x₂₁)=x₁₁+k*x₂₁ such that the signal-to-noise ratio (S/N) of the optical probe binding to or releasing from said optical sensor surface increases.

Further, the computer program product may also include a software for effecting controlled variations of the different sources of noise in embodiments of the inventions. The software may bring about controlled temperature changes or controlled changes of the composition of the medium in contact with the optical sensor surface, or effect injections of optical probe or additional binding species or other liquid compositions.

In order to provide for an accurate implementation of the methods and uses of the present disclosure and for determination of the optical probe binding to or releasing from the sensor surface, the inventor has realized the value of combining at least one optical probe species with e.g. instructions on how to use the optical probe according to the methods and uses of the present disclosure, in a single kit.

Therefore, as a ninth aspect of the invention, there is provided a reagent kit comprising at least one optical probe species and instructions on how to use it in a method according to any aspect of the invention.

The kit may also contain one or several reagents, buffers, or other chemicals, of which at least one is an optical probe species. The optical probe species may be e.g. a natural or synthetic dye molecule, a reactive dye molecule, a dye molecule coupled to another species, a coloured particle or bead, or a coloured protein. The kit is thus suitable for use for the intended method. Various components of the kits may also be selected and specified as described above in connection with the method aspects of the present disclosure.

The instructions comprises a description of how to use the kit for the intended method.

Further, as a tenth aspect of the invention, there is provided a reagent kit for use in an optical sensor, comprising at least one optical probe and a first composition, which composition induces a measurable refractive index increment (ΔRI₁) in said sensor and has an absorptivity (ε) of about 0.

The inventor has also realized the value of combining at least one optical probe and suitable compositions, e.g. a buffer, that gives rise to an increase in refractive index (ΔRI₁>0) and has low absorptivity (ε) at a wavelength of interest a in a single kit. The composition may for example be carbohydrate solution or a salt solution, which may be colorless.

In an embodiment of the tenth aspect, the kit is further comprising a second composition that induces a measurable refractive index increment (ΔRI₂) in said sensor, such that ΔRI₂≠ΔRI₁.

This is advantageous in that it provides for a known and measurable refractive index which is independent on the refractive index of the system. As an example, ΔRI₂>0 and ΔRI₂>ΔRI₁.

In a further embodiment, the kit also comprises instructions on how to use it in any method aspect of the invention above.

In yet another embodiment, the kit further comprises the computer program product according to the eighth aspect of the invention above.

Moreover, the kits of the present invention may also contain various auxiliary substances other than optical probes to enable the kits to be used easily and efficiently. Examples of auxiliary substances include solvents for dissolving optical probes of the kits and wash buffers.

### BRIEF DESCRIPTION OF THE DRAWINGS

FIG. 1 is an example of an SPR measurement of two identical measurands at two different wavelengths. In FIG. 1a, the weighted difference of the SPR minimum angles at 670 nm and 785 nm, respectively, is plotted as a function of time. In FIG. 1b, the weighted difference of the SPR minimum angles at 670 nm and 785 nm, respectively, is plotted as a function of concentration of the dye HITCI. In FIG. 1c, the predicted concentration of the dye HITCI is plotted as a function of the actual concentration after a linearizing calibration step has been performed.

FIG. 2 is an example of an SPR measurement of two different measurands at one single wavelength. In FIG. 2a, the weighted difference of the SPR peak width and the SPR minimum angle at 785 nm is plotted as a function of time. In FIG. 2b, the weighted difference of the SPR peak width and the SPR minimum angle at 785 nm is plotted as a function of concentration of the dye HITCI. In FIG. 2c, the predicted concentration of the dye HITCI is plotted as a function of the actual concentration after a linearizing calibration step has been performed.

FIG. 3 is an example of an SPR measurement of one single measurand at one single wavelength. In FIG. 3a, the SPR peak width at 785 nm is plotted as a function of time. In FIG. 3b, the SPR peak width at 785 nm is plotted as a function of concentration of the dye HITCI. In FIG. 3c, the predicted concentration of the dye HITCI is plotted as a function of the actual concentration after a linearizing calibration step has been performed.

FIG. 4 is another example of an SPR measurement of two identical measurands at two different wavelengths. In FIG. 4a, the reflected light intensities at constant angle at 785 nm and 670 nm, respectively, and the weighted sum of the light intensities are plotted as a function of time. In FIG. 4b, the weighted sum of the reflected light intensities at 785 nm and 670 nm, respectively, is plotted as a function of concentration of the dye HITCI. In FIG. 4c, the predicted concentration of the dye HITCI is plotted as a function of the actual concentration after a linearizing calibration step has been performed.

FIG. 5 shows the calculated value of (Peak width−0.1*Minimum angle) in degrees measured at 670 nm for three samples. Panel a/ shows a sucrose sample peak at about 14 minutes, panel b/ shows a dye absorbing at 636 nm, and panel c/ shows a dye absorbing at 740 nm.

FIG. 6 shows light intensity as a function of time for two samples where the dispersion in the fluidic system has been minimized. Panel a/ shows a sucrose sample and panel b/ shows a dye absorbing at 636 nm.

FIG. 7 shows the sensorgrams, i.e. the measured SPR light intensity as a function of time, for adsorption of biotin onto a streptavidin surface. FIG. 7a shows the injection of a dye labelled biotin, FIG. 7b shows the injection of unlabelled biotin, and FIG. 7c again shows the sensorgram for the labelled biotin, but now recalculated as a linear combination of the measured light intensities at two different wavelengths.

### EXAMPLES

The method of the invention will now be illustrated by the following non-limiting examples.

### Example 1

This Example was performed on an SPR instrument with angular readout and full angular scans were continuously recorded at 670 nm and 785 nm. The SPR chip was a gold covered glass chip. Continuous flow of buffer was used for baseline readings. Different concentrations of the dye HITC iodide (Aldrich 252034) in the range 0.001-0.2 mg/ml and of ethanol in the range 2-8% were injected. The dye has a strong absorbance maximum close to 740 nm. The ethanol injections served as deliberate bulk composition disturbances and also as simulated non-specific binding disturbances—this is well motivated since the relative influence on the measurands are expected to be the same for a dissolved and a bound, respectively, molecule of the same kind. Also, a deliberate thermal disturbance was introduced by raising the instrument thermostat by +4° C. From the angular scans, the measurands according to Table 1 were extracted and registered as a function of time.

TABLE 1
Theta = SPR minimum angle compared to baseline,
PW = SPR peak width at 25% intensity compared
to baseline, Thetadiff calculated according to example
1a, Anglediff calculated according to example 1b.

| | HITCI | Theta | Theta | PW | −Theta | Angle |
|---|---|---|---|---|---|---|
| Time | Conc | 785 nm | 670 nm | 785 nm | diff | diff |
| (min) | (mg/ml) | (°) | (°) | (°) | (°) | (°) |
| 5 | 0.1 | 0.082 | −0.09 | 0.1345 | 0.193 | 0.13 |
| 15 | 0.2 | 0.045 | −0.324 | 0.1945 | 0.333 | 0.1925 |
| 22 | 0.05 | −0.119 | −0.279 | 0.102 | 0.135 | 0.107 |
| 29 | 0.01 | 0.008 | −0.041 | 0.0475 | 0.049 | 0.047 |
| 35 | 0.001 | 0.007 | −0.004 | 0.0135 | 0.012 | 0.013 |
| 45 | 0.08 | 0.038 | −0.134 | 0.124 | 0.179 | 0.1225 |
| 54 | 0.01 | 0 | −0.04 | 0.043 | 0.046 | 0.0425 |
| 64 | 0.04 | 0.042 | −0.047 | 0.081 | 0.099 | 0.0785 |
| 70 | 0.2 | 0.156 | −0.121 | 0.181 | 0.316 | 0.173 |
| 77 | 0.1 | 0.09 | −0.09 | 0.1345 | 0.202 | 0.13 |
| 83 | 0.005 | 0.015 | −0.015 | 0.032 | 0.031 | 0.032 |
| 95 | 0.2 | 0.157 | −0.127 | 0.185 | 0.322 | 0.1775 |
| 112 | 2% EtOH | 0.036 | 0.045 | 0.0025 | n.d. | n.d. |
| 118 | 4% EtOH | 0.065 | 0.082 | 0.004 | n.d. | n.d. |
| 126 | 8% EtOH | 0.093 | 0.115 | 0.005 | n.d. | n.d. |
| 132 | ΔT 4° C. | −0.162 | −0.202 | −0.007 | n.d. | n.d. |

### Example 1a

Evaluation using two identical measurands at two different wavelengths. In this example the values of Theta at 670 nm and at 785 nm were utilized. In the first calibration step, the ethanol disturbance was minimized by forming the difference:

Thetadiff=Theta(670 nm)−1.25*Theta(785 nm)

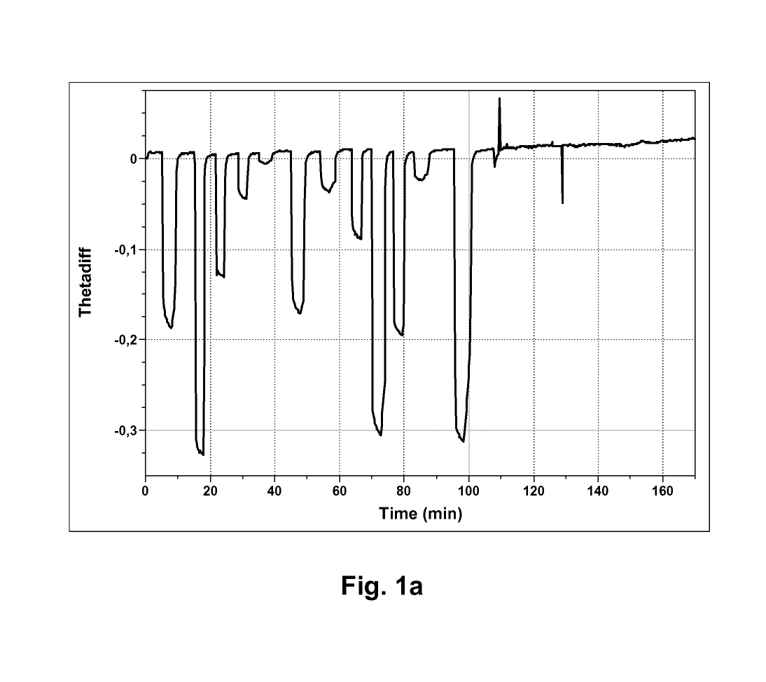

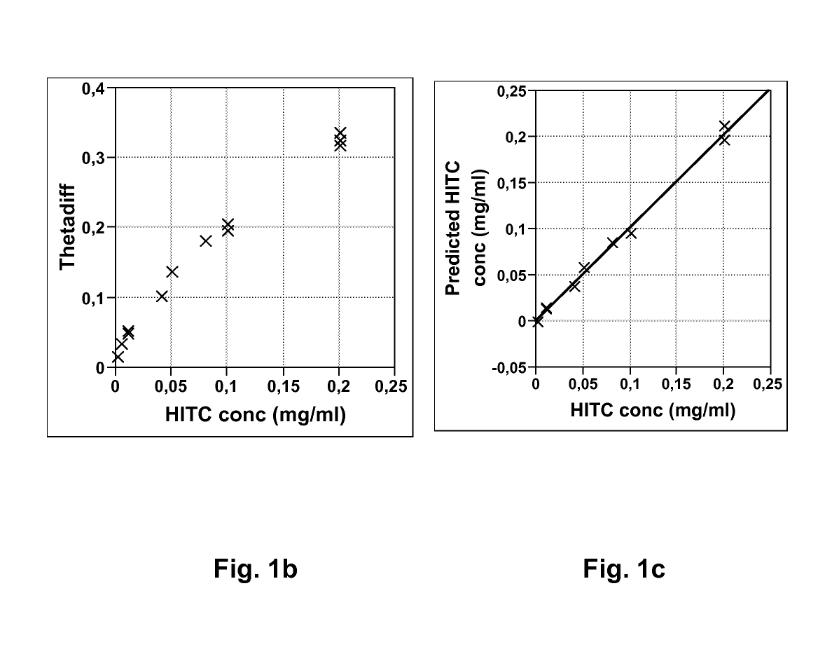

In this case, the calibration factor was −1.25. In the second calibration step, the thermal disturbance was minimized by again forming a weighted difference; it turned out that the calibration factor −1.25 worked well also in this case, and so this factor was used throughout. In FIG. 1a, Thetadiff is plotted versus time. The composition and thermal disturbances at 112 minutes and above are largely cancelled. In FIG. 1b, Thetadiff is plotted versus HITCI concentration. The sensitivity (the mass based differential refractive index increment of the HITC ion), defined as the slope of the graph close to zero concentration and corrected for the weight of the colourless iodide counterion, is about 30 ml/g (using the conversion factor 0.01 RIU/°, approximately valid for SPR in this wavelength region. RIU=Refractive Index Unit). Compared to a common reference substance like sucrose, the refractive index increment of which is 0.145 ml/g, the enhancement is a factor 200. It turned out that the response was somewhat non-linear. A third calibration step was performed by using a subset of the HITC samples (77, 83, 95 min) as a calibration set and calculating a calibration graph. The concentration of the rest of the HITC samples—simulating unknown samples—was then estimated by using this calibration graph. In FIG. 1c, the so estimated concentrations are plotted versus the true concentrations. This plot is largely linear. This example shows, that by applying appropriate calibration procedures, a high sensitivity may be obtained, the experimental noise may be largely cancelled, and the response may become linear.

A suitable reagent kit for use in similar procedures as Example 1a, may e.g. comprise 1-3 solutions of different concentrations of a reference compound (e.g. ethanol, glycerol, sucrose, or a protein), 2-4 solutions of different concentrations of a dye (e.g. HITC), and suitable dye-labelled reagents for the analytical problem at hand-labelled with the same or a spectrally similar dye as the dye used for calibration. The dye-labelled reagents may comprise e.g. a labelled analyte, a labelled analyte-analogue, a labelled substance with similar binding properties as the analyte, a labelled secondary or tertiary reagent, or a labelled substance that may bind to the analyte.

### Example 1b

Evaluation using two different measurands at one single wavelength. In this example the values of Theta and PW (Peak Width at 25% intensity) at 785 nm were utilized. In the first calibration step, the ethanol disturbance was minimized by forming the difference:

Anglediff=PW(785 nm)−0.05*Theta(785 nm)

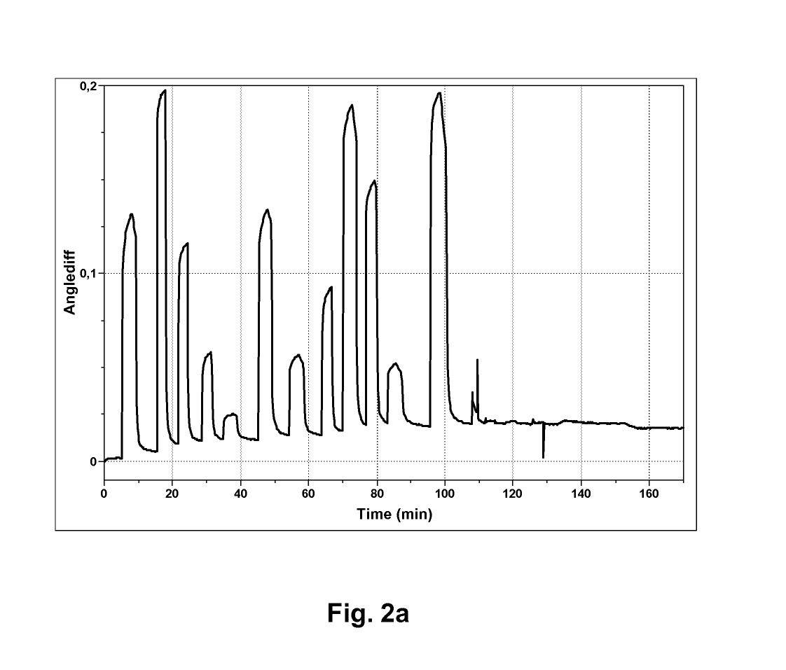

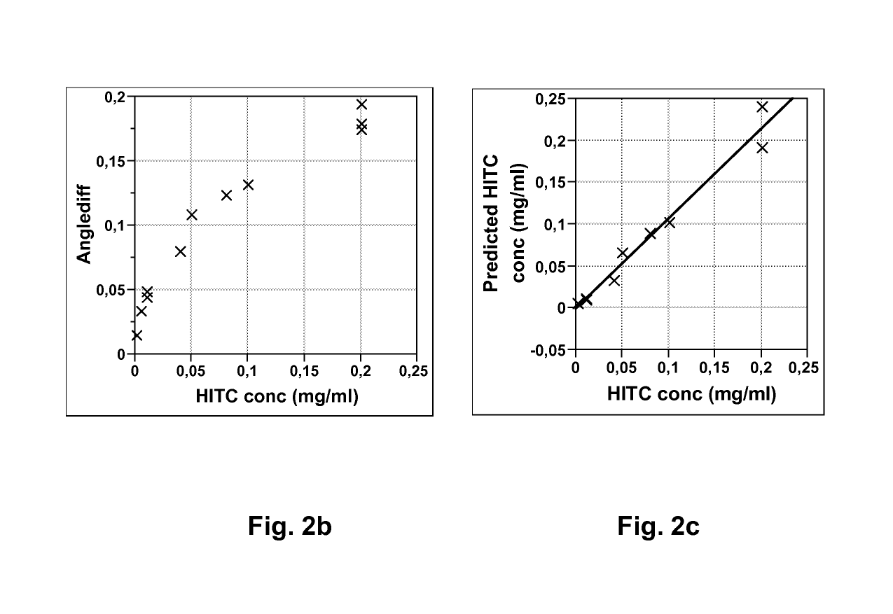

In this case, the calibration factor was −0.05. In the second calibration step, the thermal disturbance was minimized by again forming a weighted difference; it turned out that the calibration factor −0.05 worked well also in this case, and so this factor was used throughout. In FIG. 2a, Anglediff is plotted versus time. The composition and thermal disturbances at 112 minutes and above are largely cancelled. In FIG. 2b, Anglediff is plotted versus HITCI concentration. The sensitivity (the mass based differential refractive index increment of the HITC ion), defined as the slope of the graph close to zero concentration and corrected for the weight of the colourless iodide counterion, is about 30 ml/g (using the conversion factor 0.01 RIU/°, approximately valid for SPR in this wavelength region). Compared to a common reference substance like sucrose, the refractive index increment of which is 0.145 ml/g, the enhancement is a factor 200. It turned out that the response was rather non-linear. A third calibration step was performed by using a subset of the HITC samples (77, 83, 95 min) as a calibration set and calculating a calibration graph. The concentration of the rest of the HITC samples—simulating unknown samples—was then estimated by using this calibration graph. In FIG. 2c, the so estimated concentrations are plotted versus the true concentrations. This plot is largely linear. This example shows, that by applying appropriate calibration procedures, a high sensitivity may be obtained, the experimental noise may be largely cancelled, and the response may become linear.

A suitable reagent kit for use in similar procedures as Example 1b, may e.g. comprise 1-3 solutions of different concentrations of a reference compound (e.g. ethanol, glycerol, sucrose, or a protein), 2-4 solutions of different concentrations of a dye (e.g. HITC), and suitable dye-labelled reagents for the analytical problem at hand—labelled with the same or a spectrally similar dye as the dye used for calibration. The dye-labelled reagents may comprise e.g. a labelled analyte, a labelled analyte-analogue, a labelled substance with similar binding properties as the analyte, a labelled secondary or tertiary reagent, or a labelled substance that may bind to the analyte.

### Example 1c

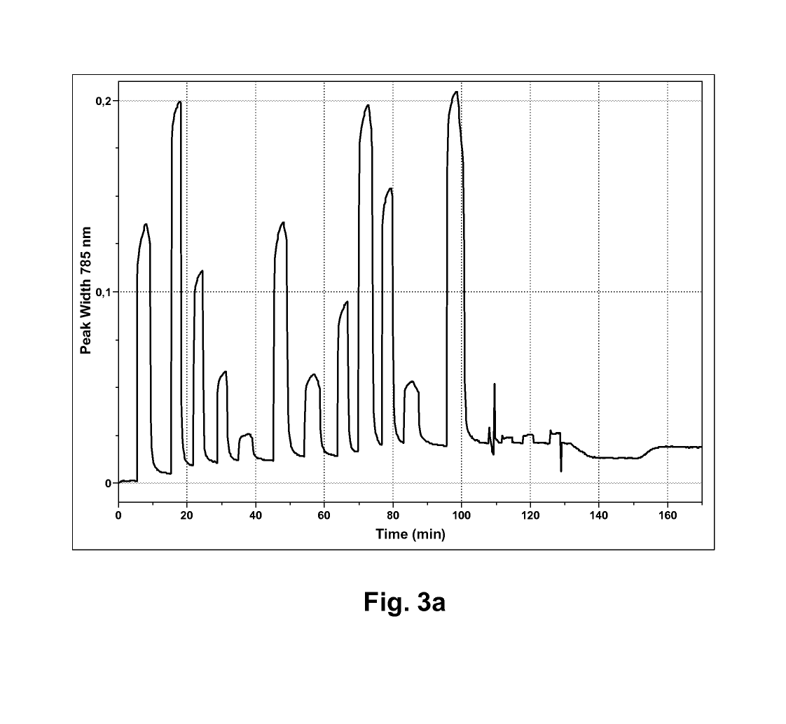

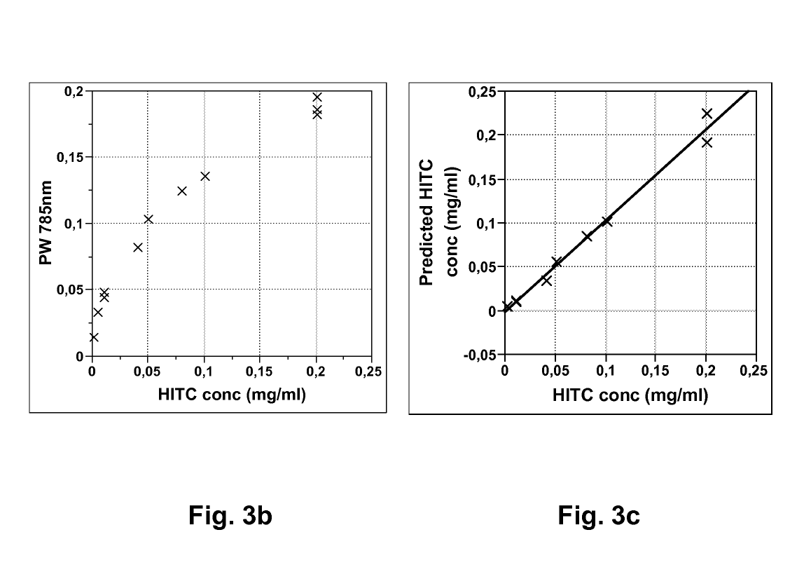

Evaluation using one single measurand at one single wavelength. In this example the value of PW at 785 nm was utilized. In FIG. 3a, PW(785 nm) is plotted versus time. PW(785 nm) shows a strong dependence on the HITC concentration but only a very weak dependence on the ethanol concentration and the temperature. The composition and thermal disturbances at 112 minutes and above are heavily reduced as compared to the Theta values. In FIG. 3b, PW(785 nm) is plotted versus HITCI concentration. The sensitivity (the mass based differential refractive index increment of the HITC ion), defined as the slope of the graph close to zero concentration and corrected for the weight of the colourless iodide counterion, is about 30 ml/g (again using the conversion factor 0.01 RIU/°, which in principle is valid for the SPR minimum angle difference, but is used here for purposes of comparison). Compared to a common reference substance like sucrose, the refractive index increment of which is 0.145 ml/g, the enhancement is a factor 200. It turned out that the response was strongly non-linear. A calibration step was performed by using a subset of the HITC samples (77, 83, 95 min) as a calibration set and calculating a calibration graph. The concentration of the rest of the HITC samples—simulating unknown samples—was then estimated by using this calibration graph. In FIG. 3c, the so estimated concentrations are plotted versus the true concentrations. This plot is largely linear. This example shows, that by applying appropriate calibration procedures, a high sensitivity may be obtained, the experimental noise may be largely cancelled, and the response may become linear.

A suitable reagent kit for use in similar procedures as Example 1c, may e.g. comprise 0-3 solutions of different concentrations of a reference compound (e.g. ethanol, glycerol, sucrose, or a protein), 2-4 solutions of different concentrations of a dye (e.g. HITC), and suitable dye-labelled reagents for the analytical problem at hand—labelled with the same or a spectrally similar dye as the dye used for calibration. The dye-labelled reagents may comprise e.g. a labelled analyte, a labelled analyte-analogue, a labelled substance with similar binding properties as the analyte, a labelled secondary or tertiary reagent, or a labelled substance that may bind to the analyte.

### Example 2

This Example was performed on an SPR instrument with angular readout but the reflected light intensity at fixed angle was recorded at 670 nm and 785 nm. The SPR chip was a gold covered glass chip. Continuous flow of buffer was used for baseline readings. Different concentrations of the dye HITC iodide (Aldrich 252034) in the range 0.2-50 ppm (mg/l) and of ethanol in the range 2-4% were injected. The ethanol injections served as deliberate bulk composition disturbances and also as simulated non-specific binding disturbances. Also, a deliberate thermal disturbance was introduced by raising the instrument thermostat by +4° C. The intensity measurands were registered as a function of time and are summarized in Table 2.

TABLE 2
Intdiff calculated with factor 1.7

| Time | HITCI conc | |
|---|---|---|
| (min) | (ppm) | −Intdiff |
| 45 | 50 | 0.05655 |
| 56 | 20 | 0.0321 |
| 69 | 5 | 0.0234 |
| 91 | 2 | 0.01175 |
| 109 | 1 | 0.0075 |
| 130 | 0.5 | 0.0094 |
| 152 | 0.2 | 0.00415 |
| 164 | 0.2 | 0.0043 |
| 181 | 0.5 | 0.0067 |
| 191 | 1 | 0.0075 |
| 213 | 2 | 0.01545 |
| 227 | 5 | 0.03295 |
| 245 | 20 | 0.03705 |
| 260 | 50 | 0.06685 |
| 265 | 2% EtOH | |
| 300 | 4% EtOH | |
| 310 | ΔT 4° C. | |

In the first calibration step, the ethanol disturbance was minimized by forming the difference (where Int is the intensity compared to baseline):

Intdiff=Int(670 nm)+1.54*Int(785 nm)

In this case, the calibration factor was 1.54. In the second calibration step, the thermal disturbance was minimized by again forming a weighted difference:

Intdiff=Int(670 nm)+1.88*Int(785 nm)

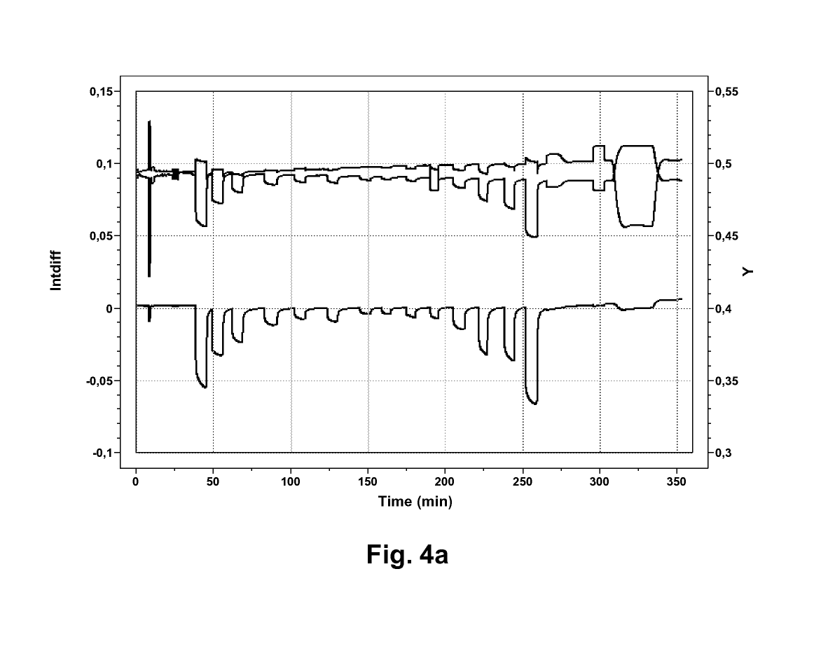

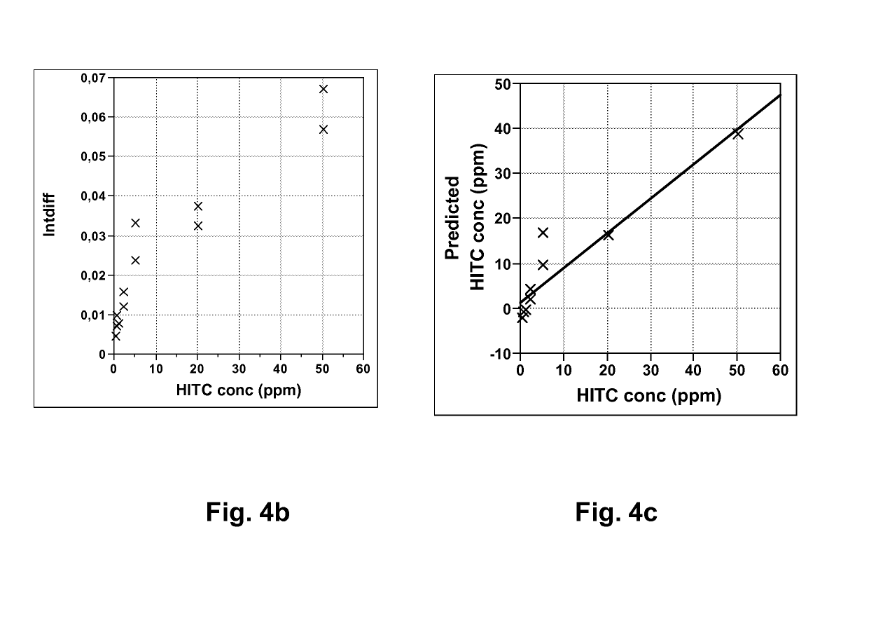

In this case, the calibration factor was 1.88. Since a single factor that worked well for both cases could not be found, a rather arbitrary intermediate factor 1.7 was used. In FIG. 4a, lower graph, Intdiff is plotted versus time. (For purposes of comparison the individual intensities at 670 nm and 785 nm, respectively, are shown as the two upper graphs with an offset.) The composition and thermal disturbances at 265 minutes and above are reduced by about 80%. In FIG. 4b, Intdiff is plotted versus HITCI concentration. The sensitivity, defined as the slope of the graph close to zero concentration and corrected for the weight of the colourless iodide counterion, is about 0.0063 Intensity Units/ppm. The short term baseline noise, estimated as the residual root mean square error when second order polynoms were fitted to a number of approximately 10-minute portions of the baseline between the HITC peaks, was 0.000047 Intensity Units. The noise level in concentration units, obtained by dividing the noise with the sensitivity, was 7.5 ppb (μg/l). The detection limit, defined as three times the noise level, was 23 ppb. The noise level may also be translated into an analogous label-free case. The noise level corresponding to 7.5 ppb of a colourless substance—again using the reference compound sucrose with a refractive index increment 0.145 ml/g as an example—is 1 nRIU. As a comparison, the noise level of commercial SPR instruments are usually in the range 100-10 000 nRIU. It turned out that the response was strongly non-linear. A third calibration step was performed by using a subset of the HITC samples (130, 245, 260 min) as a calibration set and calculating a calibration graph. The concentration of the rest of the HITC samples—simulating unknown samples—was then estimated by using this calibration graph. In FIG. 4c, the so estimated concentrations are plotted versus the true concentrations. This plot is largely linear. This example shows, that by applying appropriate calibration procedures, a high sensitivity may be obtained, the experimental noise may be largely cancelled, and the response may become linear.

A suitable reagent kit for use in similar procedures as Example 2, may e.g. comprise 1-3 solutions of different concentrations of a reference compound (e.g. ethanol, glycerol, sucrose, or a protein), 2-4 solutions of different concentrations of a dye (e.g. HITC), and suitable dye-labelled reagents for the analytical problem at hand—labelled with the same or a spectrally similar dye as the dye used for calibration. The dye-labelled reagents may comprise e.g. a labelled analyte, a labelled analyte-analogue, a labelled substance with similar binding properties as the analyte, a labelled secondary or tertiary reagent, or a labelled substance that may bind to the analyte.

### Example 3

Competition assays are frequently used in SPR. This is a conceptual example that describes such an assay. An SPR sensing surface is coated with an antibody with affinity for the analyte, and the SPR phenomenon is monitored. First, a calibration curve is run using mixtures with different but known concentrations of the analyte and of analyte or analyte analogue labelled with a suitable dye. The data is evaluated with any of the means outlined in examples 1 and 2. E.g. the SPR minimum angle is monitored at a wavelength slightly above the maximum absorption wavelength of the dye and at a wavelength slightly below the maximum absorption wavelength as in Example 1a, the influence of noise is removed, and a calibration curve is determined. Through calibration, the measurement is made specific for the labelled analyte analogue, i.e. only the amount of label is monitored. Alternatively, the SPR minimum angle and peak width is evaluated at one single wavelength in the vicinity of the maximum absorption wavelength of the dye, and the data is evaluated as set out in Example 1b. Alternatively, only the SPR peak width is evaluated at one single wavelength in the vicinity of the maximum absorption wavelength of the dye, and the data is evaluated as set out in Example 1c. In this case, the measurement is not totally specific for the dye label, but the signal from the labelled analyte is much stronger than the signal from the unlabelled analyte, so the signal from the unlabelled analyte may to a first approximation be neglected. Alternatively, the reflected light intensity is monitored at a fixed wavelength slightly above the maximum absorption wavelength of the dye and at a fixed wavelength slightly below the maximum absorption wavelength and the data is evaluated as set out in Example 2. Secondly, the unknown sample is mixed with a known concentration of the labelled analyte analogue, the SPR signal emanating from the dye is determined, and the concentration of analyte in the unknown sample is determined from the calibration curve.

Suitable reagent kits for this example are as outlined in examples 1 and 2.

### Example 4

Inhibition assays are frequently used in SPR. This is a conceptual example that describes such an assay. An SPR sensing surface is coated with the analyte or with an analyte analogue, and the SPR phenomenon is monitored. First, a calibration curve is run using pre-equilibrated mixtures with different but known concentrations of an antibody, labelled with a suitable dye, with affinity for the analyte and of analyte. The data is evaluated with any of the means outlined in examples 1 and 2. Secondly, the unknown sample is mixed with a known concentration of the labelled antibody and allowed to equilibrate. The SPR signal emanating from the dye is determined, and the concentration of analyte in the unknown sample is determined from the calibration curve.

Suitable reagent kits for this example are as outlined in examples 1 and 2.

### Example 5

Sandwich assays are frequently used in SPR. This is a conceptual example that describes such an assay. An SPR sensing surface is coated with an antibody with affinity for the analyte, and the SPR phenomenon is monitored. First, a calibration curve is run using different but known concentrations of the analyte. After each analyte injection, a secondary antibody, labelled with a suitable dye, with affinity for the analyte is injected. The SPR signal emanating from the dye is determined and evaluated through any of the calibration procedures outlined in examples 1 or 2. Secondly, the sample containing an unknown concentration of analyte is injected, followed by injection of the labelled secondary antibody, and the concentration is determined from the calibration curve.

### Example 6

Determination of kinetic and equilibrium constants of molecular interactions are frequently done using SPR. This is a conceptual example of a competitive kinetic assay using the methods suggested by the present invention. An SPR sensing surface is coated with a receptor with affinity for a ligand, and the SPR phenomenon is monitored. First, different but known concentrations of a ligand or ligand analogue labelled with a suitable dye is run, the SPR signal emanating from the dye is determined, and the kinetic constants kₒₙ and k_{off} and the equilibrium constant K_{D} are determined. The ligand analogue has an affinity for the same receptor as the ligand. The data evaluation method involves any of the methods described in examples 1 or 2. Secondly, mixtures of the ligand to be studied and of labelled ligand analogue are run. Now the ligand and the ligand analogue compete for the same affinity sites on the surface. The specific signal emanating from the dye is monitored in real time, and the kinetic and equilibrium constants of the ligand-receptor interaction are calculated through the mathematical methods of competitive kinetics (R. Karlsson, Anal. Biochem. 1994, 221, 142; R. Karlsson, A. Fält, J. Immunol. Methods 1997, 200, 121).

By using the method outlined in this example, the kinetic and equilibrium constants of a number of different ligands with affinity for the same receptor may be determined through competition with and comparison with the same labelled ligand analogue, i.e. a reference compound. Also rapid affinity ranking of different ligands may be performed. The method may be especially useful within drug screening and fragment screening, where the interaction of a receptor with a large number of different ligands is usually studied. Advantages of using the method outlined in this example includes: the signal from a dye molecule is stronger than the signal from a low molecular weight ligand, the influence of different sources of noise and background is removed through calibration, and the measurement is made specific with respect to the presence of the dye through the calibration procedure.

### Example 7

Direct binding assays are frequently used in SPR. This is a conceptual example that describes such an assay. An SPR sensing surface is coated with a single strand DNA oligonucleotide, and the SPR phenomenon is monitored. The surface is contacted with a sample containing a complementary DNA strand labelled with a suitable dye. First, calibration is performed using any of the methods outlined in example 1 or 2. Then, by analyzing the SPR signal specific to the dye, the interaction of the DNA strands is studied. The interaction includes binding and rearrangement kinetics and determination of the concentration.

### Example 8

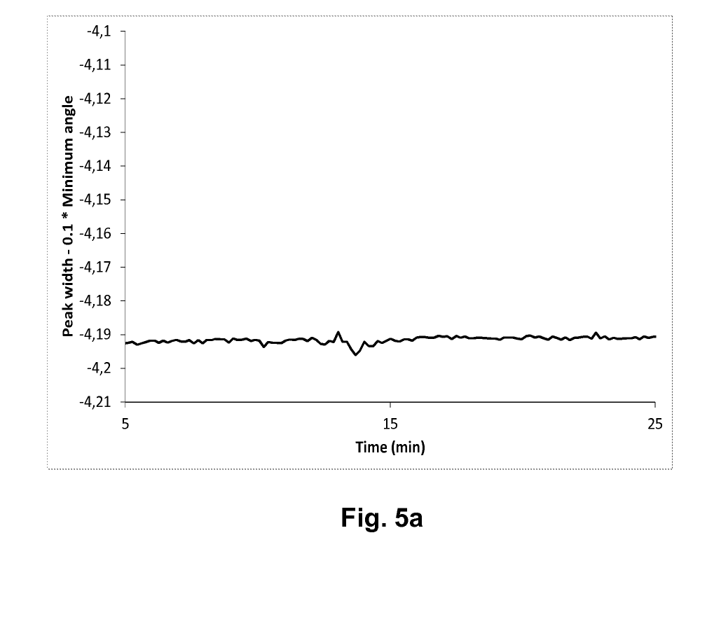

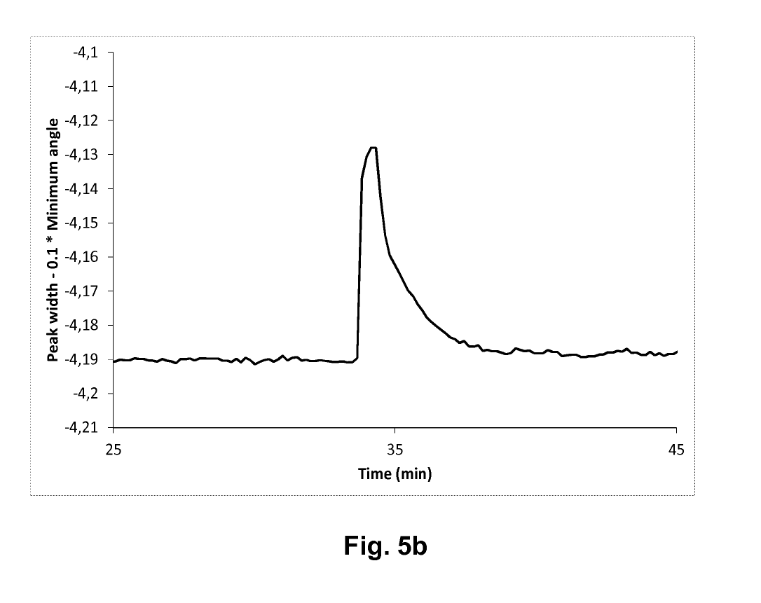

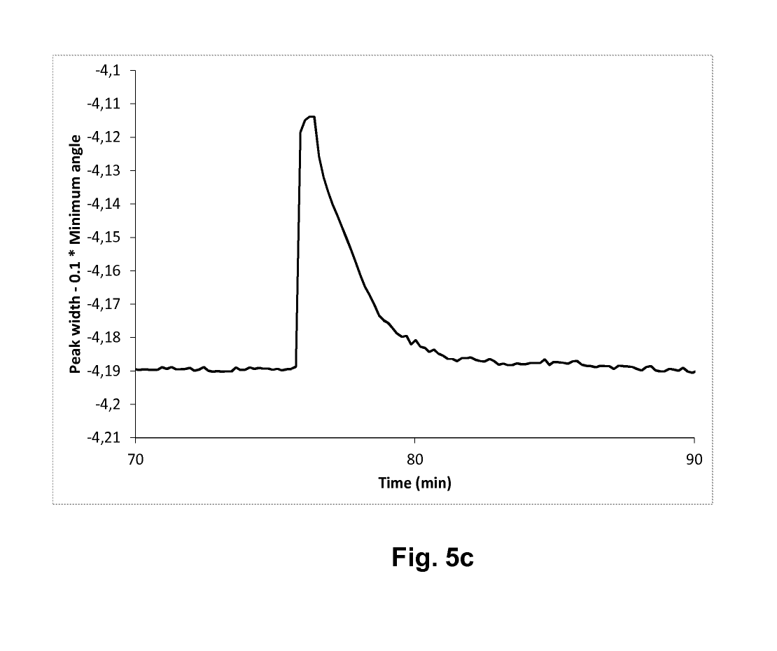

This Example was performed on an SPR instrument with angular readout and full angular scans were continuously recorded at 670 nm. The SPR chip was a gold covered glass chip. Continuous flow of buffer was used for baseline readings. First, 1% sucrose in buffer was injected as an uncoloured reference. Then, 36 ppm of a dye with maximum absorptivity 200 000 M⁻¹cm⁻¹ at 636 nm dissolved in buffer was injected as an example of a dye with a maximum absorption wavelength slightly below the SPR wavelength. Finally, 58 ppm of a dye with maximum absorptivity 215 000 M⁻¹cm⁻¹ at 740 nm was injected as an example of a dye with a maximum absorption wavelength slightly above the SPR wavelength. The SPR minimum angle and the SPR peak width at 25% intensity were monitored. For the sucrose sample, the change in minimum angle was about 0.18°. For all samples, the weighted difference (Peak width−0.1*Minimum angle) was calculated. This weighted difference is graphed in FIG. 5. For the 636 nm dye, the weighted difference equals about 0.06°, which on a per mass basis compared to the minimum angle shift for sucrose corresponds to an enhancement of about 90×. For the 740 nm dye, the weighted difference equals about 0.075°, which on a per mass basis compared to the minimum angle shift for sucrose corresponds to an enhancement of about 75×. For the sucrose sample, the weighted difference is largely negligible.

### Example 9

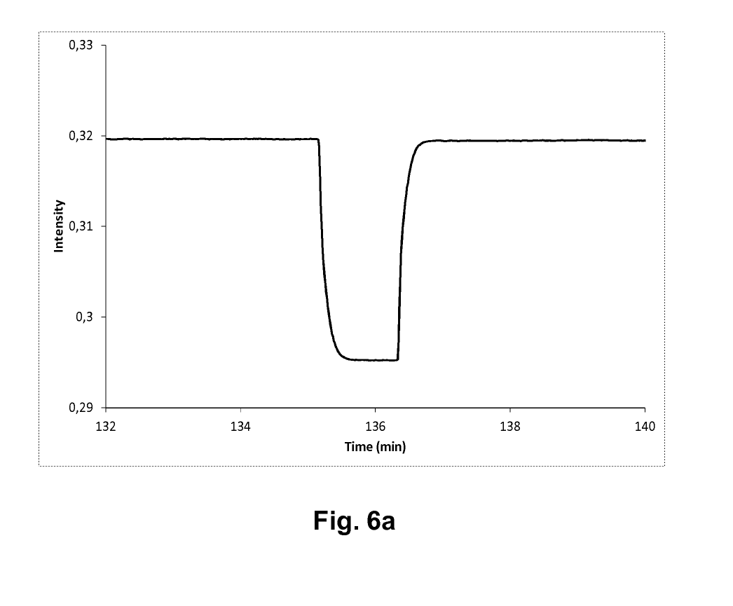

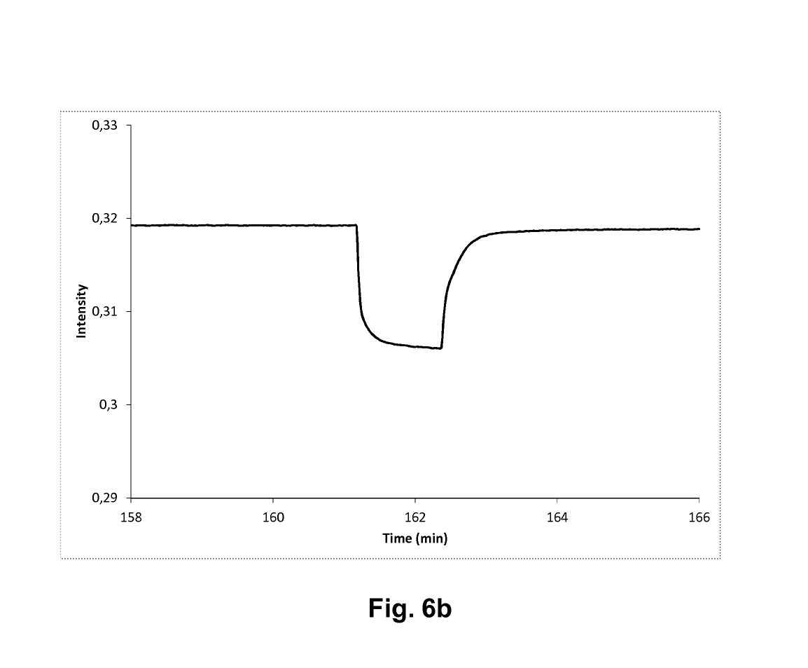

A similar setup as in Example 8 was used, but the SPR signal was read as the light intensity at constant angle 76°. Sucrose and the 636 nm dye were again used. The flow rate was 40 μl/min. Samples were introduced by filling a 100 μl injection loop with the sample and turning the injection valve to the INJECT position. However, after only 60 s, i.e. before most of the sample had left the injection loop, the injection valve was turned back to the LOAD position, thereby interrupting the injection. This was done in order to minimize the dispersion (tailing) of the sample plug in the fluidic system. The resulting injection peaks are shown in FIG. 6. As expected, in the absence of tailing, the sucrose peak returns immediately to baseline. The dye peak immediately drops to a value close to the baseline, but there is a slight tailing probably caused by adsorption of dye onto the gold surface. The interpretation is that the dominating part of the dye signal is contributed by dye in solution and only a negligible part is contributed by dye that may have been adsorbed.

### Example 10

A similar setup as in Example 8 was used, but the SPR signal was sequentially read as the light intensity at two fixed angles, 76° and 71.5°. Sucrose and the 636 nm dye were again used. The flow rate was 40 μl/min. First, 1% sucrose in buffer was injected as an uncoloured reference. Then, 36 ppm of the 636 nm dye dissolved in buffer was injected. At 76°, the intensity of the sucrose peak was 0.024 intensity units below baseline, and that of the dye peak was 0.018 intensity units below baseline. At 71.5°, the intensity of the sucrose peak was 0.045 intensity units above baseline, and that of the dye peak was 0.004 intensity units below baseline. The weighted sum [(intensity change at 76°)+0.533×(intensity change at 71.5°)] was calculated. For sucrose, this weighted sum is zero. For the dye, the weighted sum equals 0.020 intensity units. On a per mass basis and compared to the intensity change for sucrose at 71.5°, this corresponds to an enhancement of about 120×.

### Example 11

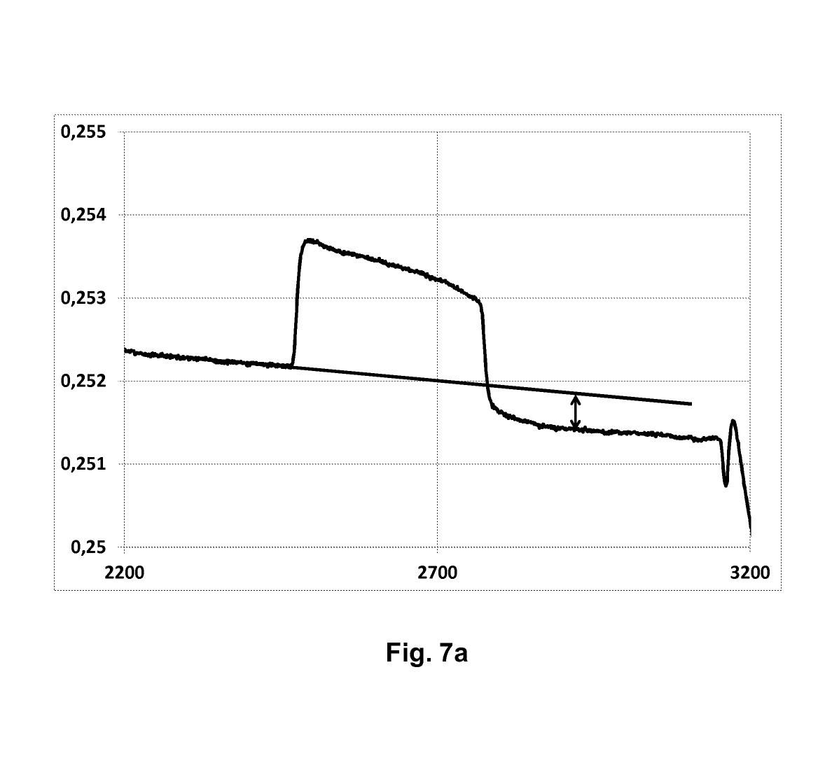

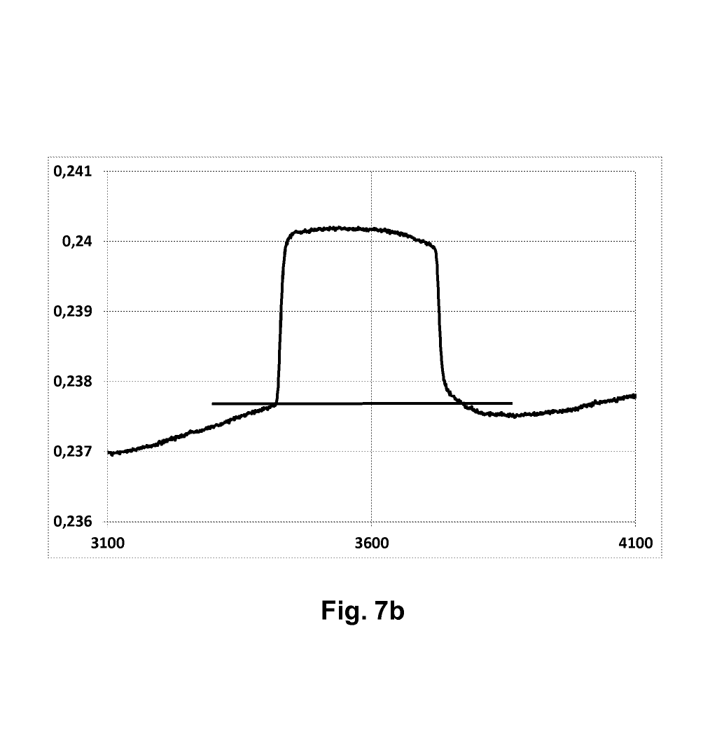

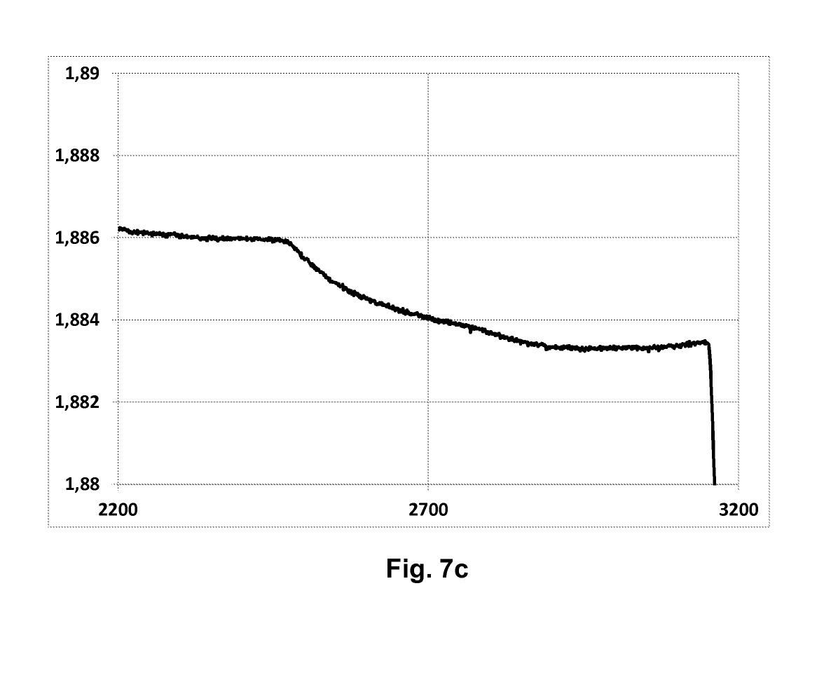

In this example, an SPR instrument reading the reflected light intensity at fixed angles at two different wavelengths, 670 nm and 785 nm, was used. The SPR chip was a gold covered glass chip, onto the surface of which had been assembled a layer of streptavidin. In a first flow channel, the chip was contacted with a solution containing 1 000 ng/ml of biotin labelled with a dye absorbing at 751 nm. In a second flow channel, the chip was contacted with a solution containing 10 000 ng/ml of unlabelled biotin. The resulting sensorgrams at 670 nm are shown in FIG. 7. The pulse shaped signals during the injections are mainly due to the bulk refractive index of the injected solutions being different from that of the baseline buffer. The biotin binds practically irreversibly to the streptavidin, so the amount of adsorbed biotin is measured as the baseline shift before and after the injection pulse, respectively. FIG. 7a shows that adsorption of the labelled biotin—in spite of a strong baseline drift—gives rise to a fully quantifiable signal of −0.0004 intensity units. FIG. 7b, on the other hand, shows that unlabelled biotin does not give rise to a detectable signal even at 10 times stronger concentration. Note that at 670 nm, the dye label is expected to cause a negative shift (an intensity decrease) while the colourless substance is expected to cause a positive shift (an intensity increase). FIG. 7c again shows the sensorgram for the labelled biotin, but now plotted as the linear combination [Intensity (760 nm)+4*Intensity (785 nm)]. The contribution from the bulk refractive difference pulse is efficiently removed, and the adsorption kinetics and the irreversible binding of biotin are clearly shown. Thus, Example 11 clearly demonstrates the advantages in using the methods of the present disclosure.

The invention is, of course, not restricted to the aspects, embodiments, and variants specifically described above, or to the specific examples, but many changes and modifications may be made without departing from the general inventive concept as defined in the following claims.

1-47. (canceled)

48. A method of determining the amount of an optical probe species binding to or releasing from an optical sensor surface, the method comprising:
a) determining, at one single wavelength or at more than one wavelength, at least one physical measurand (x₁ᵢ) that is primarily related to the refractive index of said optical probe species;
b) determining, at one single wavelength or at more than one wavelength, at least one physical measurand (x₂ⱼ) that is primarily related to the absorptivity of said optical probe species; and
c) correlating the values of said measurands to the amount of said optical probe species binding to or releasing from said optical sensor surface, respectively.

49. The method according to claim 48, wherein the correlation of step c) involves multiple linear regression, principal component analysis, factor analysis, principal component regression, partial least squares or any method of linear algebra or multivariate data analysis.

50. The method according to claim 48, wherein step c) comprises using the values of said measurands to discriminate between measurement noise (N) and the signal from the binding or release of said optical probe species.

51. The method according to claim 48, wherein step c) comprises determining at least one function f of the set of measurands: f({x₁₁, . . . , x₁ₘ; x₂₁, . . . , x₂ₙ})
such that the signal-to-noise ratio (S/N) of the optical probe species binding to or releasing from said optical sensor surface increases, wherein m≧1, n≧1.

52. The method according to claim 51, wherein f is a linear combination: f=Σᵢ₌₁_{^{m}} (k₁ᵢ x₁ᵢ)+Σⱼ₌₁_{ⁿ} (k₂ⱼ x₂ⱼ).

53. The method according to claim 50, wherein the measurement noise (N) is due to at least one additional chemical species binding to or releasing from said optical sensor surface, and that step c) comprises using the values of said measurands to discriminate between binding or releasing of said optical probe species and said at least one additional chemical species.

54. The method according to claim 48, wherein the determination of said at least one physical measurand (x₁ᵢ) that is related to the refractive index of said optical probe species and the determination of said at least one physical measurand (x₂ⱼ) that is related to the absorptivity of said optical probe species is made at one and the same single wavelength.

55. A method for calibration of an optical sensor for the determination of the amount of an optical probe species binding to or releasing from the optical sensor surface, said determination being influenced by measurement noise, wherein the calibration method comprises:
a) determining, at one single wavelength or at more than one wavelength, at least one physical measurand (x₁ᵢ) that is primarily related to the refractive index of said optical probe species;
b) determining, at one single wavelength or at more than one wavelength, at least one physical measurand (x₂ⱼ) that is primarily related to the absorptivity of said optical probe species; and
c) quantifying a specific contribution from the binding or releasing of said optical probe species to at least one of the measurands (x₁ᵢ) or (x₂ⱼ).

56. The method according to claim 55, wherein step c) involves multiple linear regression, principal component analysis, factor analysis, principal component regression, partial least squares or any method of linear algebra or multivariate data analysis.

57. The method according to claim 55, wherein step c) comprises varying the binding or release of an additional chemical species to or from, respectively, said optical sensor surface, and further comprises quantifying a specific contribution from the binding or releasing of said additional chemical species to at least one of the measurands.

58. The method according to claim 55, wherein the determination of said at least one physical measurand (x₁ᵢ) that is related to the refractive index of said optical probe species and the determination of said at least one physical measurand (x₂ⱼ) that is related to the absorptivity of said optical probe species is made at one and the same single wavelength.

59. A method for calibration of an optical sensor for the determination of the amount of an optical probe species binding to or releasing from the optical sensor surface, said determination being influenced by measurement noise, the method comprising:
a) determining at least one physical measurand (x₁ᵢ) that is primarily related to the refractive index of said optical probe species at least two wavelengths, and
b) quantifying a specific contribution from the binding or releasing of said optical probe species to at least one of the measurands, wherein the method does not involve varying the binding or release of an additional chemical species to or from, respectively, said optical sensor surface.

60. A method for calibration of a surface plasmon resonance (SPR) sensor with angular readout for the determination of an amount of an optical probe species binding to or releasing from the SPR sensor surface, said determination being influenced by measurement noise, the method comprising:
a) determining at least one reflectivity value at defined angles in the SPR curve at at least two wavelengths, and
b) quantifying a specific contribution from the binding or releasing of said optical probe species to at least one of the reflectivity values.

61. The method according to claim 48, wherein the optical sensor has a sensing principle based on surface plasmon resonance (SPR) with angular readout.

62. The method according to claim 55, wherein the optical sensor has a sensing principle based on surface plasmon resonance (SPR) with angular readout.

63. The method according to claim 59, wherein the optical sensor has a sensing principle based on surface plasmon resonance (SPR) with angular readout.

64. A computer program product comprising computer-executable components for causing a device to perform any one or all of the steps recited in claim 48 when the computer-executable components are run on a processing unit included in the device.

65. A computer program product comprising computer-executable components for causing a device to perform any one or all of the steps recited in claim 55 when the computer-executable components are run on a processing unit included in the device.

66. A computer program product comprising computer-executable components for causing a device to perform any one or all of the steps recited in claim 59 when the computer-executable components are run on a processing unit included in the device.

67. A computer program product comprising computer-executable components for causing a device to perform any one or all of the steps recited in claim 60 when the computer-executable components are run on a processing unit included in the device.

68. A reagent kit comprising at least one optical probe species and instructions on how to use it in a method according to claim 48.

69. A reagent kit comprising at least one optical probe species and instructions on how to use it in a method according to claim 55.

70. A reagent kit comprising at least one optical probe species and instructions on how to use it in a method according to claim 59.

71. A reagent kit comprising at least one optical probe species and instructions on how to use it in a method according to claim 60.
